(19) United States
(12) Patent Application Publication
(10) Pub. No.: US 2005/0210486 A1
(43) Pub. Date: Sep. 22, 2005

(54) Electronic apparatus usable in both horizontal and wall-hanging positions

(75) Inventors: Masaru Shibata, Takefu-city (JP); Tomoyuki Harada, Takefu-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Takefu-city (JP)

(21) Appl. No.: 11/079,105

(22) Filed: Mar. 15, 2005

(30) Foreign Application Priority Data
Mar. 16, 2004 (JP) 2004-074170

(51) Int. Cl. G11B 33/12

(52) U.S. Cl. 720/652

(57) ABSTRACT

The present invention is applicable to an electronic apparatus such as a DVD player, a video player, a CD player, and the like, and is preferably applicable when used in a horizontal position or in a wall-hanging position and is designed to improve operability and visibility in any one of horizontal and wall-hanging positions. By removing rubber legs 30 from engagement holes 31 and hooking the engagement holes 31 on wall-hanging members, an electronic apparatus 1 can be used in a wall-hanging position. Then, by turning an interface section 13 upward by 90 degrees, the interface section 13 located on the bottom face side can be oriented toward the front side, thus providing excellent operability of an operation section 11 made up of a plurality of operation buttons 10 including a remote controlled reception section and making a display section 12 easy to see.

The present application is based on and claims priority of Japanese patent application No. 2004-074170 filed on Mar. 16, 2004, the entire contents of which are hereby incorporated by reference.

### BACKGROUND OF THE INVENTION

1. Field of the Invention

The present invention relates to an electronic apparatus usable in both horizontal and wall-hanging positions, and more particularly, to an electronic apparatus usable in both horizontal and wall-hanging positions preferably applicable to an electronic apparatus such as a DVD player, a video player, a set top-box which receives broadcast programs broadcast according to a digital system, a CD player, and the like, connected to a television receiver used in a horizontal position or in a wall-hanging position.

2. Description of the Related Art

Among television receivers and the like, liquid crystal type television receivers using a slim flat panel such as PDP are becoming widespread in recent years and can be hung on a wall, whereas peripheral apparatuses such as a tuner, a DVD player or a video player connected to such a television receiver are generally used mainly in a horizontal position. For this reason, although a slim television receiver is hung on a wall, because a peripheral apparatus connected to the television receiver is used in a horizontal position, a useless dead space is produced, which not only makes it impossible to take advantage of the merit of space saving but also lacks unity or oneness between the wall-hung television receiver and the peripheral apparatus set in a horizontal position and this is also insufficient from the standpoint of design. Therefore, if the electronic apparatus can be used in a horizontal position as well as in a wall-hanging position, the user can select a mode of use according to the necessity, which is a great merit. As such an electronic apparatus usable in both horizontal and wall-hanging positions, Japanese Patent Laid-Open Publication No. 11-225194 (Patent Document 1) discloses a desktop/wall-hang structure for an electronic apparatus.

However, the technology disclosed in the Patent Document 1 is related to a telephone set and the invention is intended to save time and trouble in removing a base member when changing the mode of use from desktop mode to wall-hanging mode and prevent the base member from being lost until the telephone set is used on desktop next time. Therefore, it is not applicable to the peripheral apparatus connected to the aforementioned television receiver and the like, and when such a peripheral apparatus is used in a wall-hanging position, the operability and visibility of the display section become questionable. In other words, a DVD player, a video player, a CD player, and the like includes an interface section provided with a reception section of a remote-control device and operation buttons on the front and their arrangement is intended for use in a horizontal position as standard, and therefore,when used in a wall-hanging mode, there is a problem that the interface section is positioned on the bottom face or top face, which makes the use of the peripheral apparatus quite difficult.

### SUMMARY OF THE INVENTION

The present invention has been implemented in view of the above described problems and it aims at providing an electronic apparatus usable in both horizontal and wall-hanging positions with excellent operability and visibility, applicable to an electronic apparatus such as a DVD player, a video player, a set top-box which receives broadcast programs broadcast according to a digital system, a CD player, and the like, connected to a television receiver, preferably applicable when used in a horizontal position or in a wall-hanging position.

The electronic apparatus usable in both horizontal and wall-hanging positions according to the first aspect of the invention is an electronic apparatus usable in both horizontal and wall-hanging positions by forming engagement holes which engage with wall-hanging members on the bottom face of a housing of the electronic apparatus, by attaching rubber legs to the engagement holes in a detachable manner, by forming a dust-proof cover for preventing foreign matters from entering into the electronic apparatus when the apparatus is hung on the wall at the same height as that of the rubber legs, and attaching this dust-proof cover to the bottom face of the housing in a detachable manner.

When the electronic apparatus having the arrangement according to the first aspect of the invention is set in a horizontal position, the housing is supported by the rubber legs and dust-proof cover attached to the back and a buffering action of the rubber legs suppresses vibration transmitted to the electronic apparatus. Furthermore, when the electronic apparatus is hung on the wall, the rubber legs and dust-proof cover are removed from the housing, the engagement holes into which the rubber legs are fitted are hooked at wall-hanging members fixed on the wall, and in this way, it is possible to hang the electronic apparatus on the wall. In this case, it is possible to attach the dust-proof cover removed from the back of the housing to the top surface of the electronic apparatus and the dust-proof cover prevents dust from entering into the electronic apparatus.

The electronic apparatus usable in both horizontal and wall-hanging positions according to the second aspect of the invention is the electronic apparatus usable in both horizontal and wall-hanging positions according to the first aspect of the invention, wherein the engagement protrusions having a ring-shaped groove are formed in the rubber legs, the engagement hole is provided with a large hole section into which the engagement protrusion is fitted and an engagement hole contiguous to the large hole section for engaging with the ring-shaped groove and the engagement protrusion is inserted into the large hole section, and the rubber legs are slidably moved so that the rubber legs are fitted into the engagement holes.

According to the arrangement according to the second aspect of the invention, when the rubber legs are attached to the housing, the engagement protrusions of the rubber legs are inserted into the large holes of the engagement holes and the rubber legs are slidably moved sideward and the ring-shaped grooves are fitted into the engagement holes. In this way, the housing is sandwiched between the rubber legs and the engagement protrusions and the rubber legs are attached to the housing. When the rubber legs are removed from the housing, it is only necessary to slidably move the rubber legs in the reverse direction and pull out the engagement protrusions from the large hole sections.

The electronic apparatus usable in both horizontal and wall-hanging positions according to the third aspect of the invention is the electronic apparatus usable in both horizontal and wall-hanging positions according to the first or the second aspect of the invention, wherein the electronic apparatus comprises an interface section provided with an operation section including a remote controlled reception section and a display section and the like, and a rotation mechanism for rotating the interface section with respect to the housing is provided so that the interface section is placed on the front side of the housing in any one of modes of use of the electronic apparatus in horizontal and wall-hanging positions.

According to the arrangement according to the third aspect of the invention, when the mode of use is changed from the horizontally oriented mode to the wall-hanging mode, by rotating the interface section upward by 90 degrees, the interface section positioned on the bottom face side until it is rotated is oriented toward the front side, which allows the interface section to be disposed on the front side so as to face the user all the time.

The electronic apparatus usable in both horizontal and wall-hanging positions according to the fourth aspect of the invention is the electronic apparatus usable in both horizontal and wall-hanging positions according to the third aspect of the invention, wherein when the electronic apparatus is used in a horizontal position, the housing is provided with a display window extending from the front section to the top plate, this display window is built in the interface section in a freely pivotable manner, and the interface section is provided with a covering section that covers the display window except the display surface.

According to the arrangement according to the fourth aspect of the invention, when the electronic apparatus is used in a horizontal position, the display surface of the interface section faces the opening on the front side of the housing and the opening on the ceiling side is covered with the covering section. On the other hand, when the electronic apparatus is used in a wall-hanging position, the display surface of the interface section faces the opening on the ceiling side and the opening on the front side is covered with the covering section.

The electronic apparatus usable in both horizontal and wall-hanging positions according to the fifth aspect of the invention is the electronic apparatus usable in both horizontal and wall-hanging positions according to the third or the fourth aspect of the invention, wherein the control substrate provided in the interface section and the control substrate provided in the electronic apparatus are electrically connected using a flexible wiring member.

According to the arrangement according to the fifth aspect of the invention, when the interface section is rotated, the wiring member connecting the control substrate of the interface section and the control substrate of the electronic apparatus is bent in response to the operation of the interface section, which prevents the wiring member from being pulled and any excessive force being applied to the connecting section between each control substrate and the wiring member.

Since the electronic apparatus usable in both horizontal and wall-hanging positions according to the first aspect of the invention is the electronic apparatus usable in both horizontal and wall-hanging positions, constructed by forming the engagement holes which engage with the wall-hanging members on the bottom face of the housing of the electronic apparatus, attaching rubber legs to the engagement holes in a detachable manner, forming the dust-proof cover for preventing foreign matters from entering into the electronic apparatus when the apparatus is hung on the wall at the same height as that of the rubber legs and attaching this dust-proof cover to the bottom face of the housing in a detachable manner, the electronic apparatus can be used in a horizontal position as well in a wall-hanging position according to the user's need, and particularly, when the electronic apparatus is applied to a peripheral apparatus of a slim flat panel or when the television receiver is hung on the wall, the electronic apparatus can be hung on the wall in parallel thereto, and therefore, it is possible to save space, arrange the television receiver and electronic apparatus in a unified manner and provide a smart and unified design. Furthermore, when the rubber legs are removed, it is possible to hang the electronic apparatus on the wall using the engagement holes into which the rubber legs are fitted and it is not necessary to provide holes for hooking the wall-hanging members, which can also contribute to a reduction of manufacturing cost. Furthermore, by setting the dust-proof cover at the same height as that of the rubber legs, it is possible to stably support the electronic apparatus using this dust-proof cover and rubber legs and reduce the number of rubber legs to be attached to the back of the housing, thereby enabling to further reduce cost. Moreover, when the electronic apparatus is used hung on the wall, it is possible to attach the removed dust-proof cover to the housing and prevent dust from entering into the electronic apparatus.

Since the electronic apparatus usable in both horizontal and wall-hanging positions according to the second aspect of the invention is the electronic apparatus usable in both horizontal and wall-hanging positions according to the first aspect of the invention, constructed in such a way that the engagement protrusions having a ring-shaped groove are formed in the rubber legs, the engagement hole is provided with a large hole section into which the engagement protrusion is fitted and an engagement hole contiguous to the large hole section for engaging with the ring-shaped groove, and the engagement protrusion is inserted into the large hole section and the rubber legs are slidably moved so that the rubber legs are fitted into the engagement holes, it is possible to easily attach or detach the rubber legs by a simple operation of sliding the rubber legs, providing an easy way of attaching or detaching the rubber legs.

Since the electronic apparatus usable in both horizontal and wall-hanging positions according to the third aspect of the invention is the electronic apparatus usable in both horizontal and wall-hanging positions according to the first or the second aspect of the invention, constructed in such a way that the electronic apparatus comprises the interface section provided with the operation section including the remote controlled reception section and the display section, and the rotation mechanism for rotating the interface section with respect to the housing is provided so that the interface section is placed on the front side of the housing in any one of modes of use of the electronic apparatus in horizontal and wall-hanging positions, it is possible to dispose the operation section made up of a plurality of operation buttons including the remote controlled reception section on the front side of the electronic apparatus, and thereby improving operability and visibility of the electronic apparatus.

Since the electronic apparatus usable in both horizontal and wall-hanging positions according to the fourth aspect of the invention is the electronic apparatus usable in both horizontal and wall-hanging positions according to the third aspect of the invention, constructed in such a way that when the electronic apparatus is used in a horizontal position, the housing is provided with the display window extending from the front section to the top plate, in which this display window is built in the interface section in a freely pivotable manner and the interface section is provided with the covering section that covers the display window except the display surface, it is possible to prevent dust from entering from the display window into the electronic apparatus and demonstrate an excellent dust-proof characteristic.

Since the electronic apparatus usable in both horizontal and wall-hanging positions according to the fifth aspect of the invention is the electronic apparatus usable in both horizontal and wall-hanging positions according to the third or fourth aspect of the invention, constructed in such a way that the control substrate provided in the interface section and the control substrate provided in the electronic apparatus are electrically connected using the flexible wiring member, it is possible to prevent breakage of wire or contact defect and the like of the wiring member when the interface section is rotated.

### BRIEF DESCRIPTION OF THE DRAWINGS

FIG. 1 is a perspective view of an electronic apparatus according to the present embodiment;

FIG. 2 is a perspective view of the electronic apparatus according to the present embodiment viewed from the back;

FIG. 3 is an exploded perspective view of the electronic apparatus, rubber legs, and dust-proof cover according to the present embodiment;

FIG. 4 is an exploded perspective view of the electronic apparatus according to the present embodiment;

FIG. 5 is an exploded perspective view showing the interface section mounted in the front panel frame according to the present embodiment;

FIG. 6 is an exploded perspective view of the rubber leg according to the present embodiment;

FIG. 7 is a cross-sectional view showing a state in which the rubber legs are attached according to the present embodiment;

FIG. 8 is a cross-sectional view showing a state in which the interface section is rotated according to the present embodiment;

FIG. 9 is a perspective view of the electronic apparatus when used in a horizontal position according to the present embodiment;

FIG. 10 is an exploded perspective view of the electronic apparatus when used in a wall-mounting position according to the present embodiment; and

FIG. 11 is a perspective view when the electronic apparatus when used in a wall-mounting position according to the present embodiment.

### DETAILED DESCRIPTION OF THE PREFERRED EMBODIMENTS

With reference now to the attached drawings, one preferred embodiment of the present invention will be explained below.

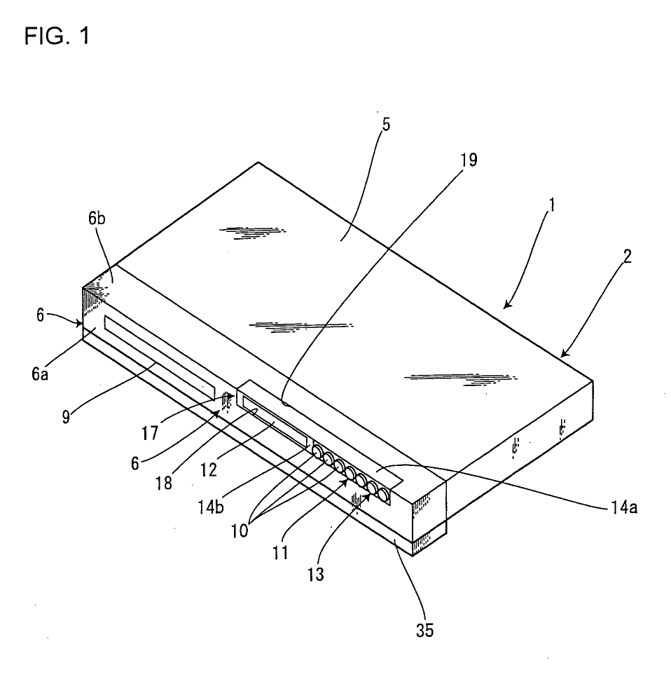

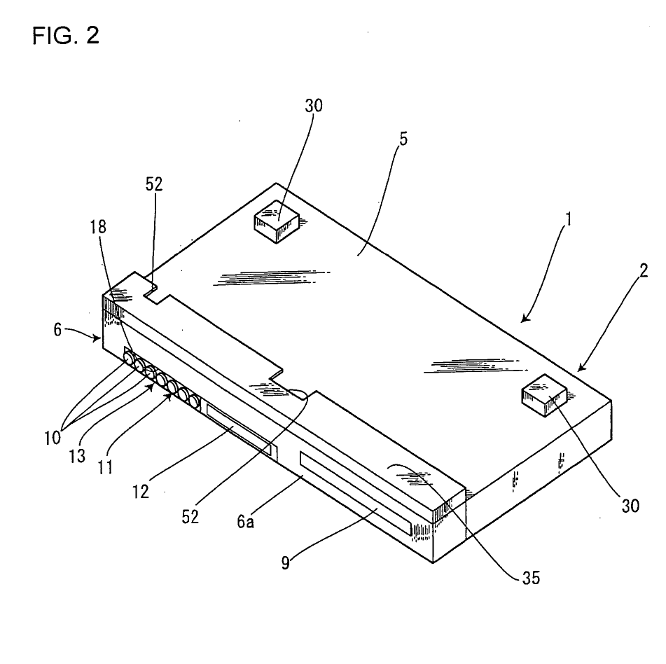

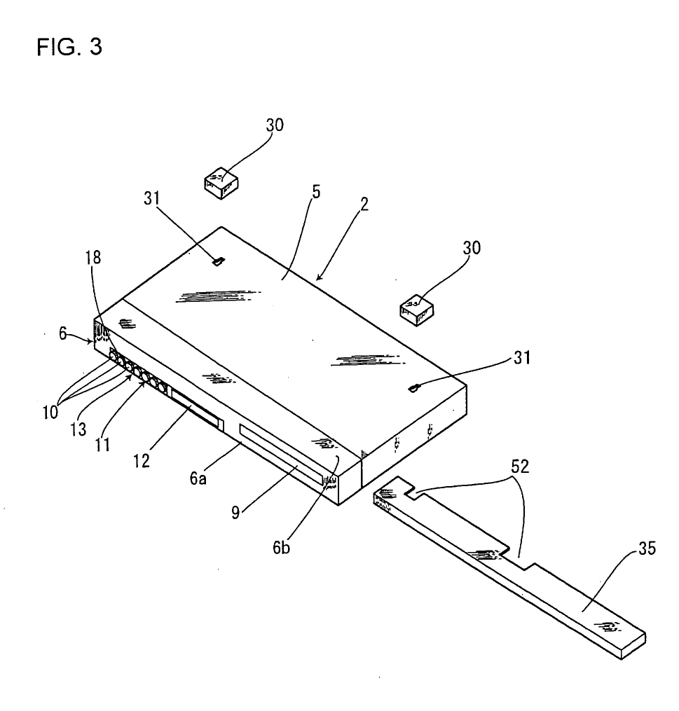

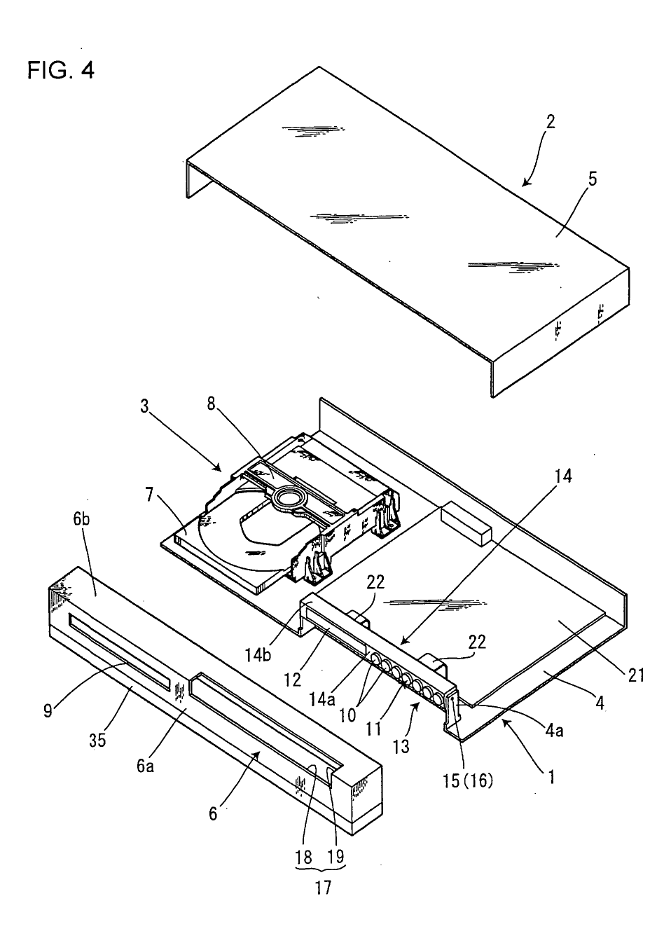

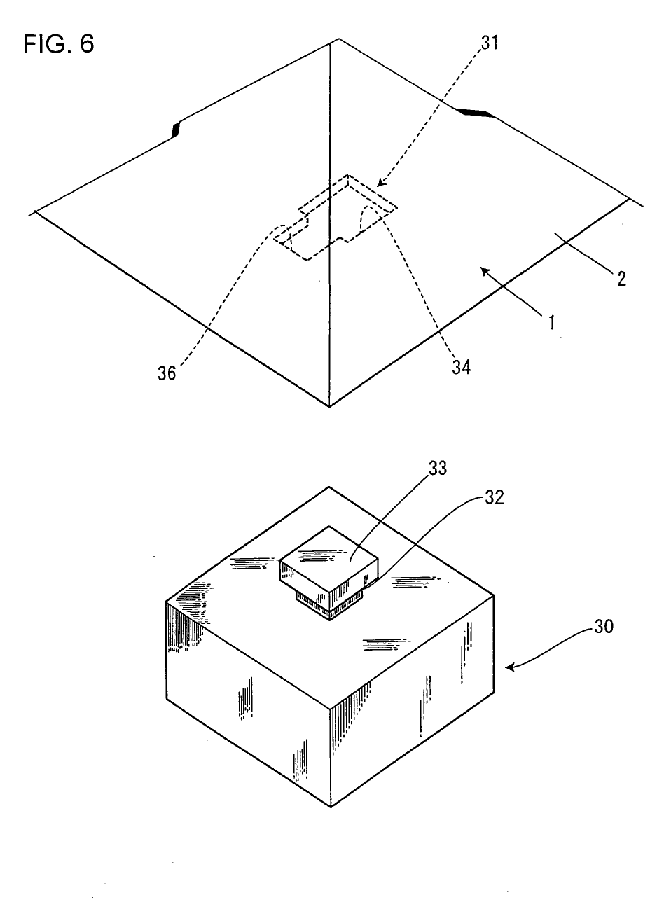

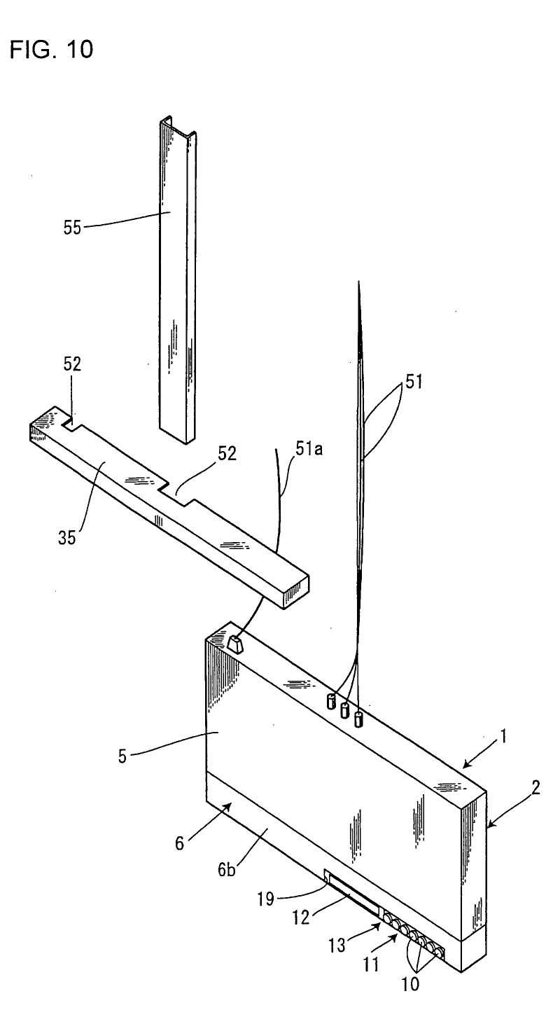

FIGS. 1 through 11 show an embodiment of the present invention and reference number 1 denotes an electronic apparatus in these figures and this embodiment will describe a case where the present invention is applied to a DVD player as an example. A housing 2 of the electronic apparatus 1 is constructed of a chassis frame 4 which fixes a DVD unit 3, an angulated U-shaped top plate cover 5 which covers this chassis frame 4, and a front panel frame 6. The DVD unit 3 is mainly constructed of a tray 7 to load or unload a disk, a turn table (not shown) which rotates and drives the disk, a pickup lens which moves back and forth in the radius direction of the disk, and the like, and these components are assembled into a frame 8 made of synthetic resin. Furthermore, a tray opening 9 which corresponds to the tray 7 is formed in the front panel frame 6 and alongside this tray opening 9 is an interface section 13 provided with an operation section 11 made up of a plurality of operation buttons 10 including a remote controlled reception section (not shown) and a display section 12 and the like.

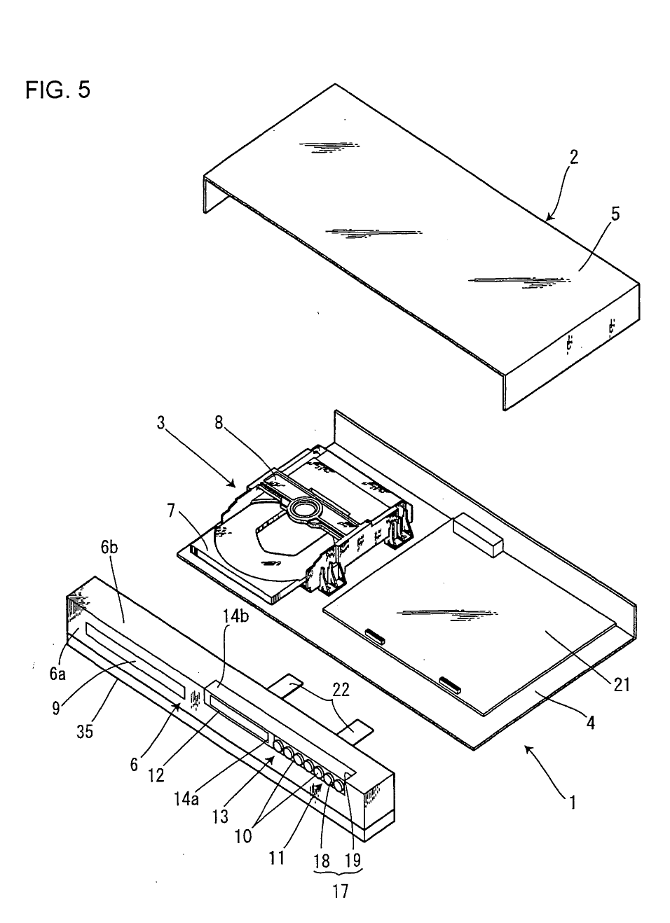

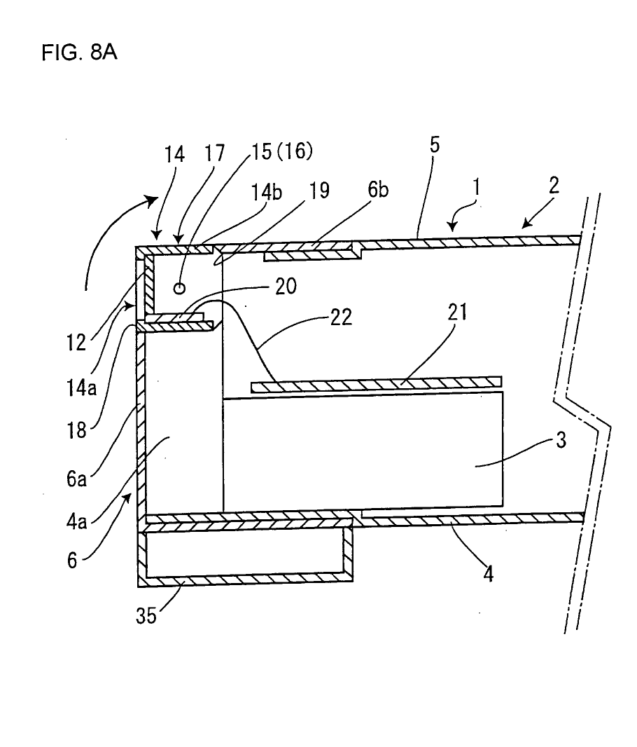

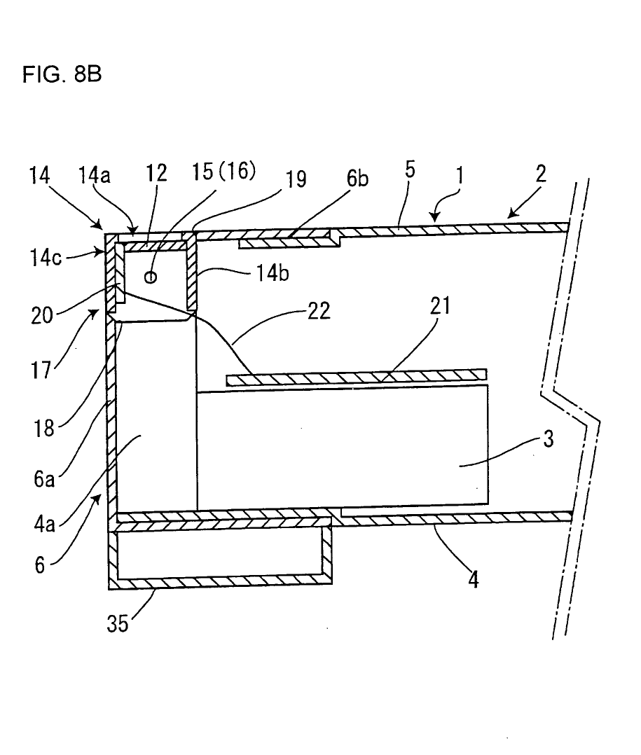

A body case 14 of the interface section 13 is engaged with a pair of right and left support plates 4a formed in the chassis frame 4 through a rotation mechanism in a pivotable manner. This rotation mechanism is constructed of a shank 15 which protrudes on both sides of the body case 14 and receiving holes 16 formed in the support plates 4a to support this shank 15 in a pivotable manner and the interface section 13 rotates around the shank 15. The rotation angle of the interface section 13 is regulated by a stopper mechanism (not shown) and the angle is determined in such away that when the electronic apparatus 1 is used in a horizontal position, the interface section 13 on the front of the front panel frame 6 is rotated approximately 90 degrees to be oriented toward the top plate cover 5. Here, the interface section 13 does not have to be necessarily engaged with the chassis frame 4 in a pivotable manner and the interface section 13 may also be engaged with the front panel frame 6 in a pivotable manner as shown in FIG. 5. Thus, the interface section 13 is engaged with the chassis frame 4 or front panel frame 6 in a pivotable manner so as to be substantially flush with the front panel frame 6 or top plate cover 5 and a display window 17 which allows the interface section 13 to be visible when the electronic apparatus 1 is used in a horizontal position and used in a wall-hanging position is formed in the front panel frame 6. This display window 17 is constructed of a front side opening 18 and a ceiling side opening 19 formed so as to extend from a front section 6a to a top plate 6b of the front panel frame 6 and when the electronic apparatus 1 is in a horizontal position, a front wall section 14a which becomes the display surface of the interface section 13 faces the front side opening 18 of the front panel frame 6 and the ceiling side opening 19 is opened, and when the electronic apparatus 1 is used in a wall-hanging position, the front wall section 14a of the interface section 13 faces the ceiling side opening 19 of the front panel frame 6 and the front side opening 18 is opened. Thus, the body case 14 of the interface section 13 is formed in an angulated U-shape including the front wall section 14a which is the display surface thereof, an upper wall section 14b which is a covering section bent from both ends of this front wall section 14a and a bottom wall section 14c, and when the electronic apparatus 1 is used in a horizontal position, as shown in FIG. 8A, the ceiling side opening 19 is covered with the upper wall section 14b and when used in a wall-hanging position, as shown in FIG. 8B, the front side opening 18 is covered with the bottom wall section 14c. Furthermore, a control substrate 20 of the interface section 13 is built in the body case 14 and this control substrate 20 and a main control substrate 21 built in the chassis frame 4 are electrically connected by a flexible flat cable (hereinafter simply referred to as “flat cable”) 22 having flexibility as a wiring member. As shown in FIG. 8, this flat cable 22 is connected to the control substrates 20 and 21 with a sag describing a curve so as to prevent the flat cable 22 from being pulled when the interface section 13 is rotated.

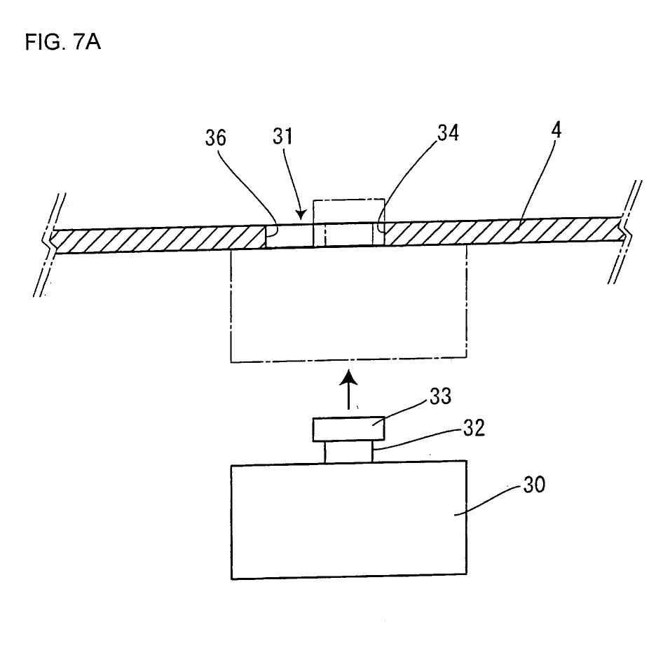

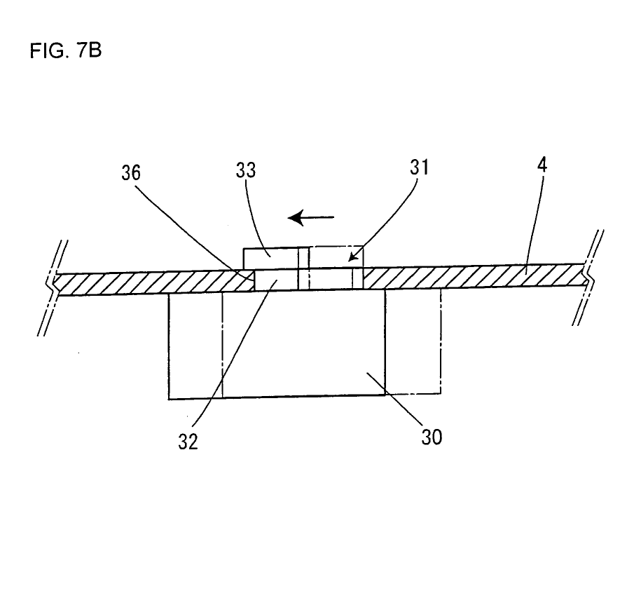

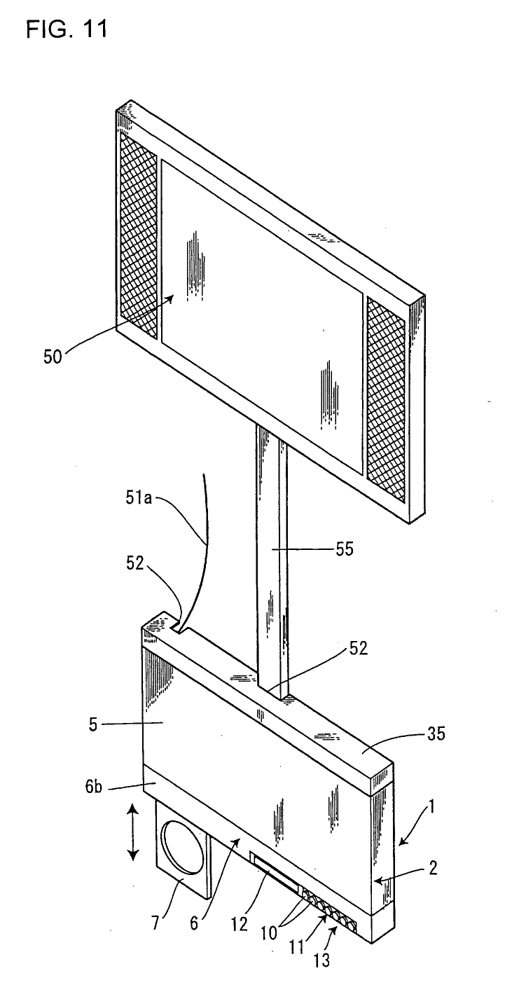

Furthermore, on the back of the housing 2, rubber legs 30 for supporting the electronic apparatus 1 when the electronic apparatus 1 is used in a horizontal position and a dust-proof cover 35 are attached in a detachable manner, the rubber legs 30 are engaged with two engagement holes 31 provided on both sides and close to the rear of the housing 2 and the dust-proof cover 35 is attached to the front end side of the front panel frame 6 fixed to the front side of the housing 2 using appropriate means such as a double-sided tape. The engagement holes 31 also serve as hooking holes of wall-hanging members (not shown) such as screws screwed into the wall, nails, or hooks when the electronic apparatus 1 is used in a wall-hanging position, and an engagement protrusion 33 having a ring-shaped groove 32 is formed integral with the rubber leg 30 and the engagement hole 31 which fixes the rubber leg 30 includes a large hole section 34 into which the engagement protrusion 33 of the rubber leg 30 is fitted and an engagement hole 36 contiguous to this large hole section 34, which engages with the ring-shaped groove 32, and is formed in a convex shape. When the rubber leg 30 is attached to the housing 2, as shown in FIG. 7A, the engagement protrusion 33 of the rubber leg 30 is inserted into the large hole section 34 of the engagement hole 31 and then as shown in FIG. 7B, the rubber leg 30 is slidably moved sideward so as to allow the ring-shaped groove 32 to engage with the engagement hole 36 thereby attaching the rubber leg 30 to the housing 2. When the rubber leg 30 is removed from the housing 2, it is possible to slidably move the rubber leg 30 in the opposite direction and pull out the engagement protrusion 33 from the large hole section 34. Furthermore, the dust-proof cover 35 is formed into the same height as that of the rubber legs 30 and substantially the same length as the width of the front panel frame 6. This dust-proof cover 35 is used to cover a cable 51 connected to the electronic apparatus 1 and the lead-out part of a power cable 51a and notches 52 are formed at positions corresponding to the cable 51 and power cable 51a leading out of the electronic apparatus 1. The electronic apparatus 1 comes with a cable cover 55 routed along the wall, which covers the cable 51 between the electronic apparatus 1 and the television receiver 50 when the electronic apparatus 1 is used in a wall-hanging position. Furthermore, this embodiment explains a case where the invention is applied to a DVD player as an example of the electronic apparatus 1, and in the case of the DVD player, when the electronic apparatus 1 is hung on the wall, as shown in FIG. 11, the tray 7 which loads or unloads a disk is located on the bottom face side and the disk is loaded or unloaded in a vertical direction, and therefore, the tray 7 has a structure allowing the disk to be held in the vertical condition.

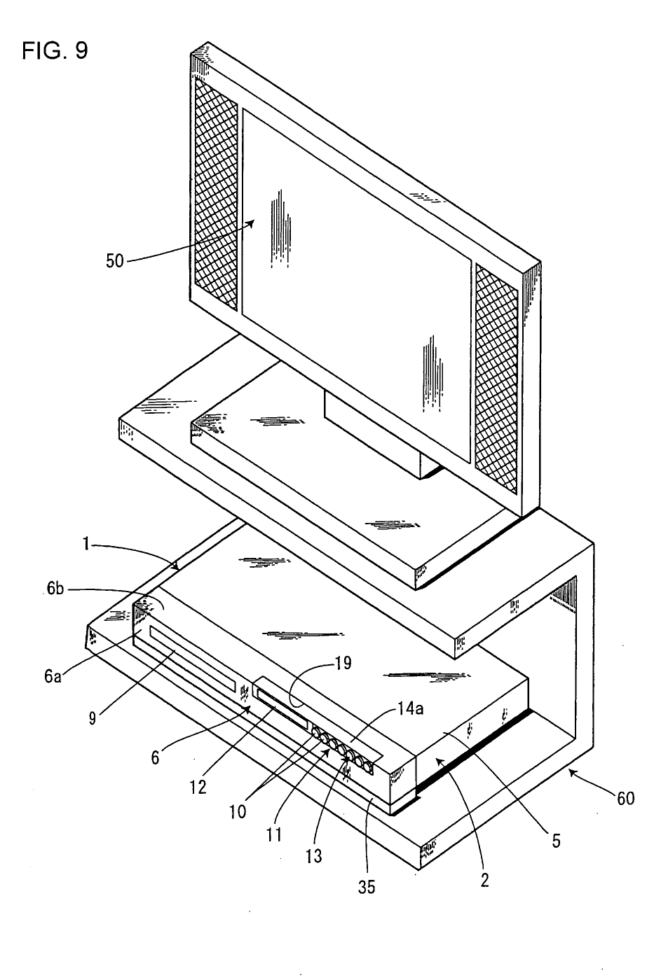

Next, various methods of use of this embodiment in the above described structure will be explained more specifically with reference to FIGS. 9 through 11.

First, as shown in FIG. 9, when the television receiver 50 is placed, for example, on a rack 60 and the electronic apparatus 1 is set in a horizontal position thereunder, the rubber legs 30 are attached to the housing 2. That is, as shown in FIG. 7A, the ring-shaped groove 32 of the rubber leg 30 is engaged with the engagement hole 36 and the rubber leg 30 is fitted into the engagement hole 31 and the dust-proof cover 35 is attached to the front end side of the housing 2. This allows vibration transmitting to the electronic apparatus 1 to be absorbed through the buffering action of the rubber legs 30 and allows the electronic apparatus 1 to be disposed in a stable condition. Thus, when the electronic apparatus 1 is used in a horizontal position, the interface section 13 is disposed facing the front side opening 18 with the ceiling side opening 19 of the front panel frame 6 covered with the upper wall section 14b of the interface section 13.

Next, the case where the electronic apparatus 1 is used in a wall-hanging position will be explained with reference to FIG. 11. When the television receiver 50 is hung on the wall, the electronic apparatus 1 is hung on the wall thereunder. In this case, wall-hanging members such as screws must be fixed to the wall first, then the rubber legs 30 are slidably moved so as to pull out the engagement protrusions 33 from the large hole sections 34, and the rubber legs 30 are removed from the housing 2 and the dust-proof cover 35 is removed from the housing 2. Then, the engagement holes 31 are hooked at the wall-hanging members fixed to the wall, and then the electronic apparatus 1 and television receiver 50 are connected using the cable 51. Then, the dust-proof cover 35 is attached to the housing 2 so as to cover the lead-out part of the cable 51 leading out of the electronic apparatus 1, and the cable cover 55 which comes with the electronic apparatus 1 is attached to the wall to cover the cable 51 between the electronic apparatus 1 and the television receiver 50. At this time, the cable cover 55 is inserted into a notch 52 formed in the dust-proof cover 35 to connect the dust-proof cover 35 and the cable cover 55 in a T-shape. After the electronic apparatus 1 is hung on the wall, the interface section 13 is turned upward by 90 degrees, the interface section 13 disposed on the bottom face side up to that time is oriented toward the front, and therefore, the operation section 11 made up of a plurality of operation buttons 10 has excellent operability, which makes the display section 12 easy to see. Since the control substrate 20 of the interface section 13 and the main control substrate 21 built in the housing 2 are electrically connected with the flat cable 22 bent without tension, when the interface section 13 is rotated, the flat cable 22 follows the rotation naturally allowing the control substrates 20, 21 to be connected stably without any danger such that an excessive force may be applied to the flat cable 22 causing breakage of wire or contact defects. Furthermore, when the electronic apparatus 1 is used in a wall-hanging position, the front side opening 18 used to make the interface section 13 visible is covered with the bottom wall section 14c formed in the body case 14 of the interface section 13, and therefore, when the electronic apparatus 1 is used in any one of horizontal and wall-hanging positions, the display window 17 except the display surf ace of the interface section 13 is covered with the upper wall section 14b or bottom wall section 14c, preventing foreign matters such as dust from entering inside.

As shown above, according to this embodiment, when the television receiver 50 is set on the rack 60 and the like, and the electronic apparatus 1 such as a DVD player connected as a peripheral apparatus of the television receiver 50 is set in a horizontal position and when the television receiver 50 is used in a wall-hanging position, it is possible to use the electronic apparatus 1 in a wall-hanging position. Thus, it is possible to use the electronic apparatus 1 in a horizontal position or in a wall-hanging position according to the user's need, and particularly, when the television receiver 50 is used in a wall-hanging position, by hanging the electronic apparatus 1 on the wall in parallel to the television receiver 50, it is possible to set the television receiver 50 and the electronic apparatus 1 in a compact manner, save space and arrange the wall-hanging type television receiver 50 and the electronic apparatus 1 which is a peripheral apparatus thereof on the wall in a unified manner, realizing a unified design also from the standpoint of the interior design. Furthermore, when the electronic apparatus 1 is used in a horizontal position, the rubber legs 30 for supporting the electronic apparatus 1 are attached to the engagement holes 31 in a freely detachable manner, and therefore, when used in a wall-hanging position, by removing the rubber legs 30, it is possible to use the engagement holes 31 as hooking holes. This eliminates the necessity for providing the holes for attaching the rubber legs 30 and the holes for hooking the wall-hanging members separately, and therefore, it is possible to simplify the manufacturing steps. Furthermore, by fixing the dust-proof cover 35 for covering the cable 51 leading out of the electronic apparatus 1 to the back of the housing 2 in a freely detachable manner and making the height of the dust-proof cover 35 equal to the height of the rubber legs 30, when the electronic apparatus 1 is used in a horizontal position, the rubber legs 30 and the dust-proof cover 35 can support the electronic apparatus 1 stably and also reduce the number of the rubber legs 30 to be attached to the back of the housing 2, thereby reducing the manufacturing cost of the electronic apparatus 1. Moreover when the electronic apparatus 1 is used in a wall-hanging position, covering the connecting section of the cable 51 pulled out of the electronic apparatus 1 and covering the cable 51 between the electronic apparatus 1 and the television receiver 50 with the cable cover 55 which comes with the electronic apparatus 1 by removing the dust-proof cover 35 from the electronic apparatus 1, it is possible to cover the cable cover 55 in a way that is pleasing to the eye and provide the dust-proof cover 35 capable of preventing dust from entering from the connecting section of the cable 51 into the electronic apparatus 1. Furthermore, when used in any one of horizontal and wall-hanging positions, rotating the interface section 13 with respect to the housing 2 provides excellent operability of the operation section 11 made up of a plurality of operation buttons 10 including the remote controlled reception section and makes the display section 12 easy to see, improving the visibility thereof. Furthermore, by electrically connecting the control substrate 20 of the interface section 13 and main control substrate 21 built in the housing 2 using the flat cable 22 with flexibility, when the interface section 13 is rotated, it is possible to stably connect the control substrates 20, 21 without any excessive force applied to the flat cable 22. Furthermore, since the upper wall section 14b and bottom wall section 14c which cover the front side opening 18 and ceiling side opening 19 which serves as the display window 17 are formed in the body case 14 of the interface section 13, it is possible to prevent foreign matters such as dust from entering into the electronic apparatus 1.

An embodiment of the present invention has been explained in detail as above, however, the present invention is not limited to this embodiment and can be modified in various ways within the scopes of the present invention. For example, this embodiment has explained the case of the DVD player as an example of the electronic apparatus, however, the application of the present invention is not limited to the DVD player and is also applicable to electronic apparatuses other than the DVD player. Furthermore, the rotation mechanism whereby the interface section 13 is rotated with respect to the housing 2 is not limited to the above described embodiment and can be selected as appropriate.

1. An electronic apparatus usable in both horizontal and wall-hanging positions comprising engagement holes which engage with wall-hanging members formed on a bottom face of a housing of the electronic apparatus,rubber legs attached to the engagement holes in a detachable manner, and
a dust-proof cover for preventing foreign matters from entering into the electronic apparatus when the apparatus is hung on the wall formed at the same height as that of the rubber legs,
wherein the dust-proof cover is attached to the bottom face of the housing in a detachable manner.

2. The electronic apparatus usable in both horizontal and wall-hanging positions according to claim 1, wherein engagement protrusions having a ring-shaped groove are formed in the rubber legs, the engagement hole is provided with a large hole section into which the engagement protrusion is fitted and an engagement hole contiguous to the large hole section for engaging with the ring-shaped groove and the engagement protrusion is inserted into the large hole section, and the rubber legs are slidably moved so that the rubber legs are fitted into the engagement holes.

3. The electronic apparatus usable in both horizontal and wall-hanging positions according to claim 1 or 2, wherein the electronic apparatus comprises an interface section provided with an operation section including a remote controlled reception section and a display section and a rotation mechanism for rotating the interface section with respect to the housing is provided so that the interface section is placed on the front side of the housing in any one of modes of use of the electronic apparatus in horizontal and wall-hanging positions.

4. The electronic apparatus usable in both horizontal and wall-hanging positions according to claim 3, wherein when the electronic apparatus is used in a horizontal position, the housing is provided with a display window extending from the front section to the top plate, the display window is built in the interface section in a freely pivotable manner, and the interface section is provided with a covering section that covers the display window except the display surface.

5. The electronic apparatus usable in both horizontal and wall-hanging positions according to claim 3, wherein a control substrate provided in the interface section and a control substrate provided in the electronic apparatus are electrically connected using a flexible wiring member.

6. The electronic apparatus usable in both horizontal and wall-hanging positions according to claim 4, wherein a control substrate provided in the interface section and a control substrate provided in the electronic apparatus are electrically connected using a flexible wiring member.
